(19) United States
(12) Patent Application Publication
(10) Pub. No.: US 2013/0222539 A1
(43) Pub. Date: Aug. 29, 2013

(54) SCALABLE FRAME COMPATIBLE MULTIVIEW ENCODING AND DECODING METHODS

(71) Applicants: Peshala V. Pahalawatta, Glendale, CA (US); Alexandros Tourapis, Milpitas, CA (US)

(72) Inventors: Peshala V. Pahalawatta, Glendale, CA (US); Alexandros Tourapis, Milpitas, CA (US)

(73) Assignee: Dolby Laboratories Licensing Corporation, San Francisco, CA (US)

(21) Appl. No.: 13/876,824

(22) PCT Filed: Sep. 19, 2011
(86) PCT No.: PCT/US11/52214

§ 371 Date: Mar. 28, 2013

Related U.S. Application Data
(60) Provisional application No. 61/391,562, filed on Oct. 8, 2010.

(51) Int. Cl. H04N 13/00

(52) U.S. Cl. CPC H04N 13/0048
USPC 348/43

(57) ABSTRACT

A scalable frame compatible three-dimensional video encoding and decoding system for use in a multiview video coding system is described. A base layer includes low resolution information from a plurality of views while one or more enhancement layers may include high resolution information for at least one of the plurality of views. Interpolation filters are derived based on a combination of low resolution information and high resolution information are discussed. For a given view, sending high resolution information at some times and low resolution information at other times are also described.

### CROSS-REFERENCE TO RELATED APPLICATIONS

This application claims priority to U.S. Provisional Patent Application No. 61/391,562 filed 8 Oct. 2010, hereby incorporated by reference in its entirety. The present application may be related to U.S. Provisional Application No. 61/223,027, filed on Jul. 4, 2009, U.S. Provisional Application No. 61/300,115, and U.S. Provisional Application No. 61/300,427, all of which are incorporated herein by reference in their entirety.

### TECHNOLOGY

The present invention relates generally to video processing. More specifically, an embodiment of the present invention relates to scalable frame compatible multiview encoding and decoding.

### BACKGROUND

Recently, there has been considerable interest in the industry towards the creation and delivery of 3D content. A number of high grossing 3D movies have kindled the interest, and many broadcasters have also begun broadcasting selected sports events in 3D. Adding to the interest has been the availability of a number of 3D capable displays that use a variety of technologies to provide a stereoscopic 3D viewing experience to the home viewer. Therefore, there is significant interest in providing a stereoscopic 3D video delivery scheme that can bring 3D content to the home viewer.

The Stereo High Profile of the Multi View Coding (MVC) extension (Annex H) of H.264/AVC was recently finalized and has been adopted as the video codec for the next generation of Blu-Ray discs (Blu-Ray 3D) that feature stereoscopic content (see reference [1]). This method assumes that the viewer possesses both a 3D capable playback device, such as a 3D Blu-Ray player, as well as a 3D capable TV in order to experience stereoscopic 3D. On the other hand, another method that does provide for the delivery of 3D content through legacy playback devices is that of frame compatible 3D video delivery.

### BRIEF DESCRIPTION OF DRAWINGS

FIG. 1 shows an implementation of a scalable video coding scheme that utilizes spatial scalability.

FIG. 2 shows an implementation of a scalable video coding scheme that utilizes spatial and temporal scalability.

FIG. 3 shows an embodiment of a scalable video encoding architecture with full resolution encoding of selected views.

FIG. 4 shows an embodiment of a scalable video decoding architecture for use with the encoding architecture of FIG. 3.

FIG. 5 shows an embodiment of a method for upsampling one view based on information from another view.

FIG. 6 shows an embodiment of a method for upsampling views based on signaled filter parameters.

FIG. 7 shows an embodiment of a method for encoding one view based on inter-layer prediction information from another view.

FIG. 8 shows an embodiment of a scalable video coding scheme in which a particular view is encoded in an enhancement layer at certain time instants and not encoded in the enhancement layer at other time instants.

### DESCRIPTION OF EXAMPLE EMBODIMENTS

According to a first aspect of the disclosure, A frame compatible multiview video encoding system adapted to receive information from a plurality of views is provided, comprising: a base layer comprising a base layer encoder, wherein the base layer encoder encodes information from the plurality of views to obtain a first encoded frame compatible image; and one or more enhancement layers, wherein each enhancement layer is associated with the base layer and each enhancement layer comprises an enhancement layer encoder, wherein at least one view and less than the entirety of views in the plurality of views is encoded by the enhancement layer encoder to obtain a set of encoded images.

According to a second aspect of the disclosure, a frame compatible multiview video encoding system adapted to receive information from a plurality of views is provided, comprising: a base layer comprising a base layer encoder, wherein the base layer encoder encodes information from the plurality of views to obtain a first encoded frame compatible image; and one or more enhancement layers, wherein: each enhancement layer is associated with the base layer, each enhancement layer comprises an enhancement layer encoder, the entirety of views in the plurality of views is encoded by at least one of the enhancement layer encoders, at least one view and less than the entirety of views in the plurality of views is encoded by each remaining enhancement layer encoder, the enhancement layer encoders generate a set of encoded images.

According to a third aspect of the disclosure, a multiview video decoding system adapted to receive information from a plurality of views is provided, comprising: a base layer comprising a base layer decoder adapted to receive the information from the plurality of views and adapted to decode the information from the plurality of views to obtain a first decoded frame compatible image; one or more enhancement layers, wherein each enhancement layer is associated with the base layer and each enhancement layer comprises an enhancement layer decoder, wherein the one or more enhancement layers are adapted to receive information from at least one and less than the entirety of views in the plurality of views and adapted to decode the information from the at least one and less than the entirety of views in the plurality of views to obtain a set of decoded images; and an upsampling module comprising an input from the base layer decoder and one input from each enhancement layer decoder, wherein the upsampling module performs interpolation on a full set or subset of views in the plurality of views.

According to a fourth aspect of the disclosure, a multiview video decoding system adapted to receive information from a plurality of views is provided, comprising: a base layer comprising a base layer decoder adapted to receive the information from the plurality of views and adapted to decode the information from the plurality of views to obtain a first decoded frame compatible image; and one or more enhancement layers, wherein: each enhancement layer is associated with the base layer, each enhancement layer comprises an enhancement layer decoder, at least one of the enhancement layer decoders is adapted to receive and decode the entirety of views in the plurality of views, each remaining enhancement layer decoder is adapted to receive and decode at least one and less than the entirety of views in the plurality of views, and the enhancement layer decoders generate a set of decoded images.

According to a fifth aspect of the disclosure, a method for deriving interpolation filters is provided, the interpolation adapted for use in a multiview video coding system, the multiview video coding system comprising a base layer and one or more enhancement layers, the method comprising: a) providing a first coded image based on a plurality of views; b) providing at least one coded image based on at least one and less than the entirety of views in the plurality of views; and c) generating filter modes for the interpolation filters based on views in the first coded image and the at least one coded image.

According to a sixth aspect of the disclosure, a method for performing interpolation on a full set or subset of views in a first coded image based on at least one coded image is provided, the first coded image comprising information from a plurality of views, and the at least one coded image comprising information from a subset of the plurality of views, the method comprising: a) deriving interpolation filters based on filter modes received from an encoder; and b) filtering the first coded image using the interpolation filters obtained from the step of deriving, wherein the filter modes are filter parameters or filter indices, and wherein the filter indices are adapted to provide information on type of filter to use for decoding the first coded image and the at least one coded image.

According to a seventh aspect of the disclosure, a method for encoding an image, the coded image adapted for use in a multiview video coding system is provided, the method comprising: encoding a particular view at a low spatial resolution and a high temporal resolution in a first set of time instants; and encoding the particular view at a high spatial resolution and a low temporal resolution in a second set of time instants.

According to an eighth aspect of the disclosure, a method for encoding an image, the coded image adapted for use in a multiview video coding system, the method comprising: encoding a particular view at a high resolution in a first set of times instants; and encoding the particular view at a low resolution in a second set of time instants.

Frame compatible stereoscopic 3D delivery refers to delivery of stereoscopic content in which original left and right eye images are first downsampled, with or without filtering, to a lower resolution (typically half the original resolution) and then packed together into a single image frame (typically of the original resolution) prior to encoding. Many subsampling (e.g., horizontal, vertical, and quincunx) and packing (e.g., side-by-side, over-under/top-and-bottom, line-by-line, and checkerboard) methods exist for frame compatible stereoscopic video delivery. Since the frame compatible technique provides a reduced resolution image for each view, various schemes have been proposed for providing a scalable approach that uses a frame compatible base layer and then adds an additional enhancement layer or layers to improve the final decoded resolution of the views.

An exemplary reference that proposes various schemes for providing such a scalable approach is U.S. Provisional Application No. 61/223,027, entitled “Encoding and Decoding Architectures for Format Compatible 3D Video Delivery”, filed on Jul. 4, 2009, incorporated herein by reference.

A number of generic scalable video coding techniques have also been proposed in the video coding community to provide encoded bitstreams that are scalable in terms of spatial and temporal resolution, bit-depth, quality, etc. The Scalable Video Coding (SVC) extension of the MPEG-4 AVC/H.264 standard (see references [1] and [2]) is one example of such a scheme that provides various levels and forms of scalability.

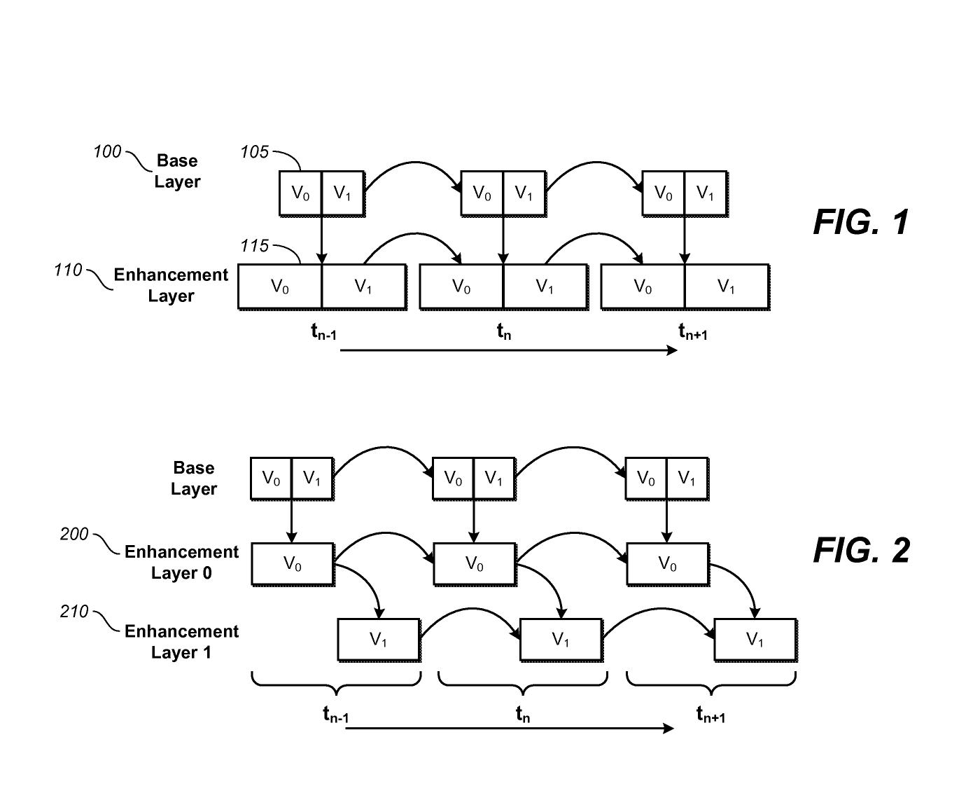

Existing scalable video coding techniques can be used without modification for multiview video delivery. FIG. 1 illustrates one possible implementation of a scalable video coding technique. In this implementation, a scalable video encoder is used to encode a frame compatible image (105) in a base layer (100). Then, an enhancement layer (110) can be encoded using the spatial scalability mode of the scalable codec such that the enhancement layer (110) provides a higher resolution image (115) that improves resolution of each view (V₀ and V₁ in FIG. 1) compared to the resolution of the view in the frame compatible image (105). Note that although FIG. 1 shows a case with only two views, the same techniques can be applied to additional views as well. Also, the frame compatible packing scheme can be one of many possible schemes such as side-by-side, over-under, and so forth.

FIG. 2 illustrates another possible implementation of a scalable video coding technique. This implementation uses both spatial and temporal scalability to provide a scalable frame compatible full resolution scheme. In this implementation, a first enhancement layer (200) uses spatial scalability to improve resolution of one view, and then a second enhancement layer (210) uses temporal scalability to increase overall frame rate such that additional views can be encoded as temporal enhancement layers.

The above methods are compatible with existing architectures of a scalable video codec, but may be inefficient in terms of compression. This disclosure details methods that can be used to extend scalable video techniques, such as those proposed in SVC, to provide for scalable frame compatible multiview delivery of video. Specifically, this disclosure provides schemes that aim to improve compression efficiency of frame compatible full resolution video within a scalable video coding framework.

According to many embodiments of the present disclosure, compression efficiency may be improved by limiting information that is used to provide additional spatial or temporal resolution to one or more views of a multi-view sequence by re-using information from the other view or views of the sequence.

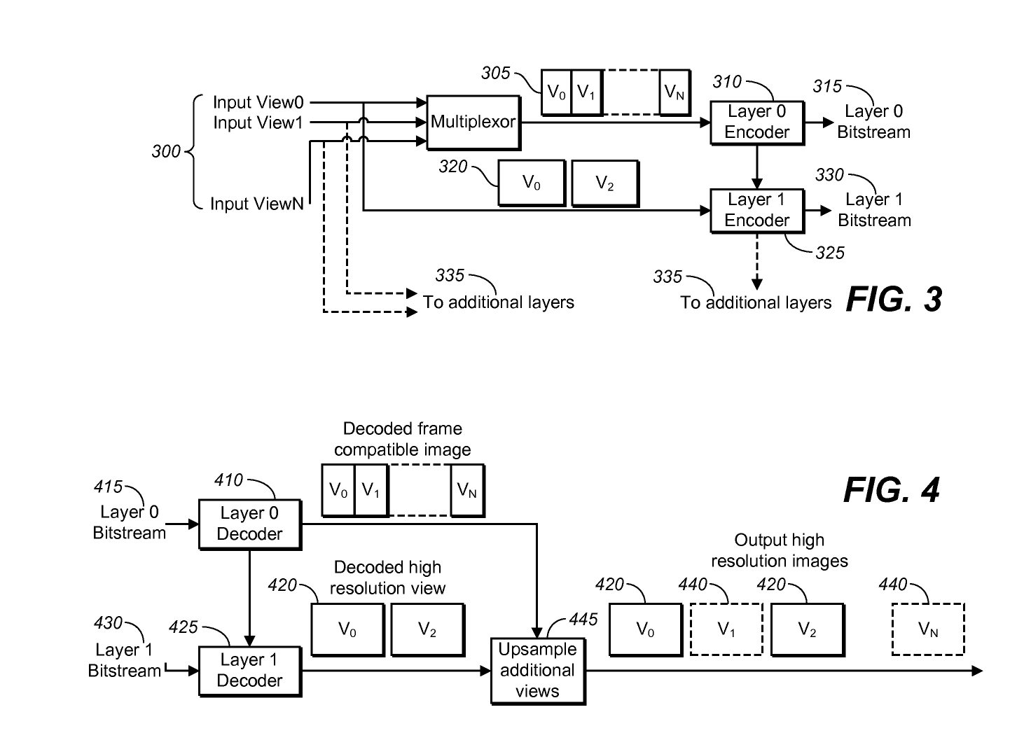

FIG. 3 shows an embodiment of a frame compatible scalable video encoding architecture. In this embodiment, a frame compatible base layer comprising a frame compatible base layer image (305), which contains low resolution versions of each view (300), is first encoded by a base layer encoder (310) to obtain a base layer frame compatible bitstream (315). Then, in a simple case, spatial or temporal scalability is used to encode, via an enhancement layer encoder (325), higher spatial or temporal resolution versions for one or more, but not all, of the views (320) to obtain an enhancement layer frame compatible bitstream (330). The other views remain in the low resolution form. It should be noted that one or more, but not all, of the views may also be encoded at additional enhancement layers (335), as shown in FIG. 3. Additionally, each layer does not necessarily have a separate bitstream. Information from the base layer and the one or more enhancement layers may be encoded into a single bitstream or a plural number of bitstreams less than the total number of layers.

FIG. 4 shows an embodiment of a frame compatible scalable video decoding system that is compatible with the encoding architecture of FIG. 3. The decoding system comprises one or more decoders (410, 425) that decode a base layer frame compatible bitstream (415) as well as an enhancement layer bitstream or bitstreams (430). Then, enhancement layer views (420) are displayed at full resolution while remaining views (440) are displayed at lower resolution.

In one embodiment, the low resolution views (440) can be upsampled (445), in an upsampling module (445), using simple interpolation filters such as 1D or 2D FIR, bilinear, or bicubic filters as well as more complex filters such as edge adaptive filters, bilateral filters, edgelet and bandlet based methods, and so forth, prior to display. This method of providing a lower resolution for some views (440) can be justified, especially in the stereoscopic 3D case, due to stereo masking effects that have been observed in numerous studies of the human visual perception of stereoscopic 3D images (see reference [3]).

The upsampling (445) of low resolution views (440) does not, however, need to be completely agnostic of characteristics of the original full resolution images (300) (shown in FIG. 3). In fact, there can be significant correlation between the views (300) in a multi-view sequence. Therefore, higher resolution enhancement layer encodings (330) that are available for some of the views (420) can be a significant source of information in improving the resolution of the remaining views (440).

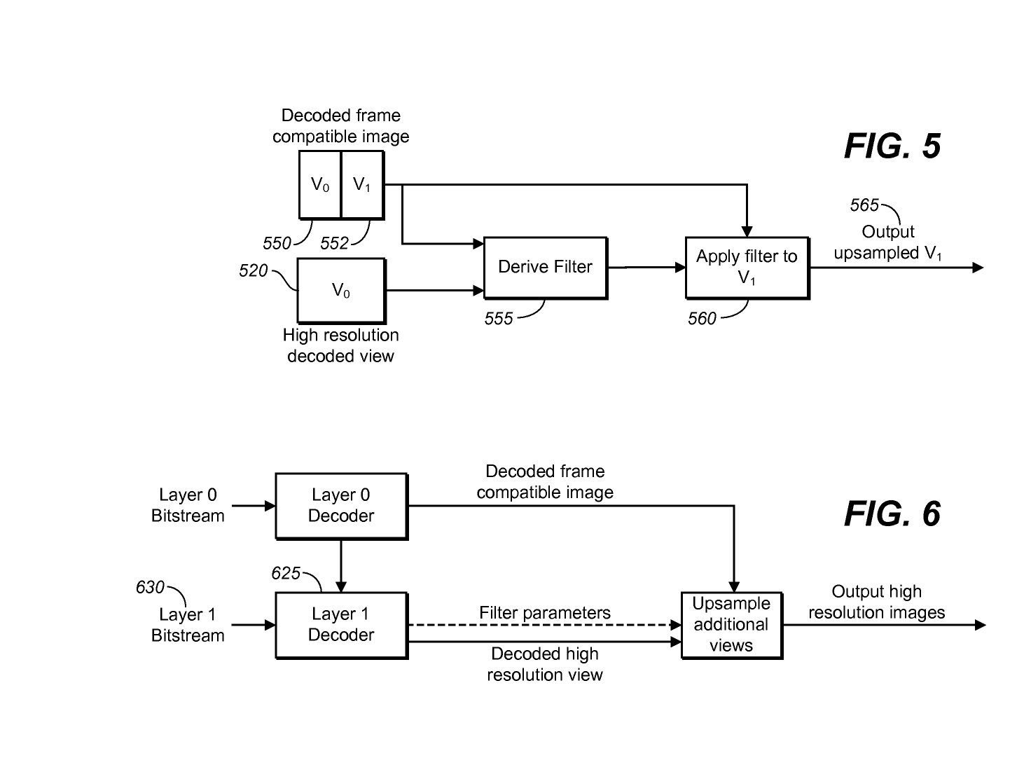

For example, FIG. 5 illustrates an embodiment where a decoded high resolution view (520), specifically a high resolution version of V₀ (520), and corresponding decoded low resolution view (550), specifically a low resolution version of V₀ (550), can be input into a filter derivation module (555) that performs a filter derivation process (555). The filter derivation process (555) derives filter parameters that generally provide the closest representation of the decoded high resolution view (520) using the decoded low resolution view (550). It should be noted that “closeness” will be defined in the paragraph that follows. Specifically, a filter designed using the derived filter parameters, when applied to the low resolution version of V₀ (550), will generally provide the closest representation of the high resolution version of V₀ (520). Then, these filter parameters can be used on the other remaining low resolution view or views (552) in order to interpolate the remaining low resolution view or views (552) to the higher resolution. For instance, in FIG. 5, the remaining low resolution view (552) is V₁. The filter derived by the filter derivation process (555) is applied to V₁, as illustrated by block 560, to obtain an upsampled (in other words, higher resolution) V₁ (565).

“Closeness” of the representation of the interpolated view (565) to the decoded high resolution view (520) can be measured, in a simple case, in terms of the Sum Squared Error (SSE). Using the SSE, the derived filter parameters will be ones that provide minimum mean squared error for the interpolated view (565). An exemplary reference that introduces methods of deriving minimum mean squared error filter parameters is U.S. Provisional Application No. 61/300,427, entitled “Adaptive Interpolation Filters for Multi-layered Video Delivery”, filed on Feb. 1, 2010, incorporated herein by reference. In another embodiment, the closeness may be measured in terms of some other characteristic, or combination of characteristics, such as distortion measures (e.g., SSIM, weighted PSNR, and VDP), similarity of edges and texture, similarity of first and second order moments, similarity of frequency characteristics, and so forth.

In another embodiment, optimal filter parameters for a given criterion or criteria may be derived at a block, or region, level such that different filter parameters may be derived for different spatial and temporal regions of an image. With continued reference to FIG. 5, in one embodiment, the same filter parameters may be used to interpolate co-located regions of the low resolution view (552). Specifically, a particular block or region in the low resolution view V₁ (552) can utilize the filter parameters derived from a co-located block or region in V₀ (550).

In another embodiment, filter parameters may be derived for co-located positions. For instance, with continuing reference to FIG. 5, filter parameters derived for a particular position (x,y) in the low resolution version of V₀ (550) can be applied to the same position (x,y) in the low resolution view V₁ (552). Furthermore, motion/disparity estimation may be performed between the low resolution decoded views (550, 552). In this case, instead of using filter parameters derived for co-located positions (x,y), filter parameters derived for positions with highest spatial correlation to a position in the image to be upsampled (552) will be used for upsampling. For instance, for each value of x and y, motion estimation may yield that a particular position (x,y) in V₁ (552) should utilize filter parameters derived for a position (x+Δx,y+Δy) in V₀ (550).

In an additional embodiment, interpolated samples obtained from the low resolution image (552) may be combined with decoded samples from a high resolution view (520) to obtain a combined view that is a weighted combination of the two views (520, 552). This embodiment may also be applied together with motion estimation to further improve quality of the combined view. Given that the low resolution views (550, 552) from the frame compatible images and the high resolution views (520) from the enhancement layers can be treated as asymmetric quality samples, certain techniques may be used to improve quality of the upsampled versions (565) of the low resolution view (552) or views. An exemplary reference that describes such techniques is U.S. Provisional Application No. 61/300,115, entitled “Filtering for Image and Video Enhancement using Asymmetric Samples”, filed on Feb. 1, 2010, incorporated herein by reference.

Derivation of upsampling filters can be computationally complex for decoders. FIG. 6 illustrates an embodiment in which the upsampling filters are derived in an encoder, as opposed to a decoder, and then signaled in an enhancement layer bitstream (630). The signaling can take the form of, for example, Supplemental Enhancement Information (SEI) messages in the video bitstream (630). An enhancement layer decoder (625) receives the filter information and performs the upsampling. Note that the methods previously described that involve combining interpolated and decoded views are still applicable in this case. Also, the filter information may not be limited to specifying a specific set of filter coefficients. Instead, the filter information may serve as a recommendation of a particular filter type to be used by the decoder (630). Filter selection, in this case, can be further improved by using an original high resolution view (not shown) as a guide to determining the filter parameters, instead of using a decoder reconstruction of a different view. Note, however, that reduced decoder complexity in the embodiment shown in FIG. 6 is at the cost of additional signaling bits for the filter information.

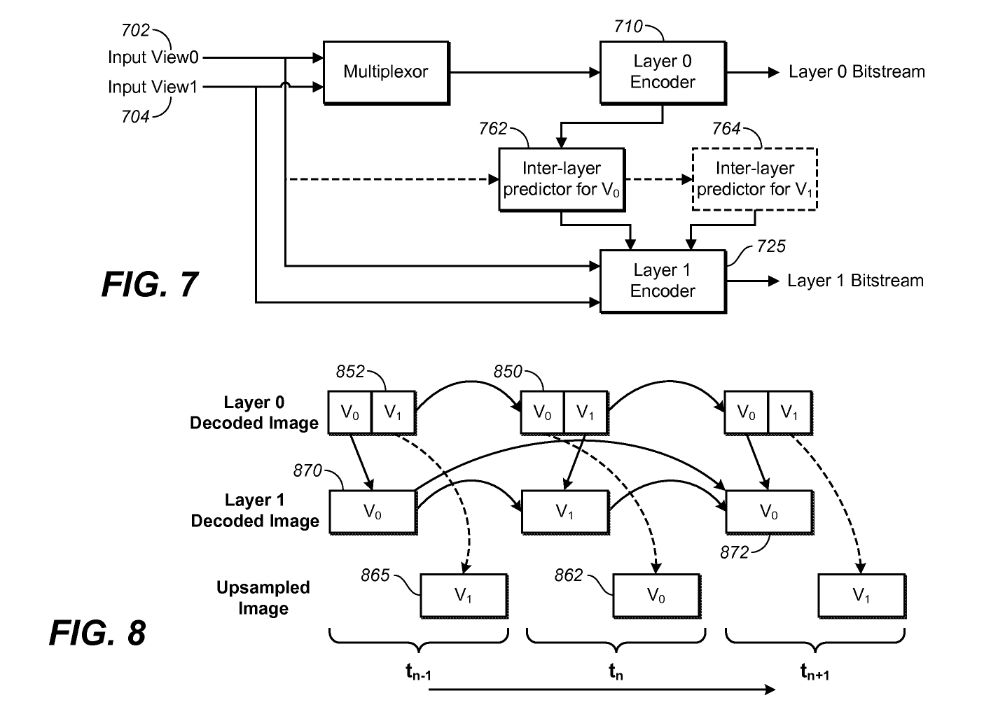

FIG. 7 illustrates another embodiment in which scalable video coding techniques can be utilized for frame compatible multiview video delivery. The embodiment in FIG. 7 allows for reduced or no signaling of inter-layer prediction information for some views. As shown in FIG. 7, the inter-layer prediction information may be generated using an inter-layer predictor for V₀ (762) and an inter-layer predictor for V₁ (764). Specifically, inter-layer prediction information is signaled for one view, for instance either V₀ (702) or V₁ (704), in order to generate high resolution reconstructed images for that view in an enhancement layer.

Such inter-layer prediction information (762, 764) can include inter-layer motion vector predictor errors. For example, in existing spatially scalable video codecs, a scaled motion vector from a lower layer encoder (710) may be used as a predictor for coding of a motion vector for a co-located block of the next layer. Then, only a difference vector needs to be signaled in the enhancement layer.

In one embodiment, for co-located blocks with lower layer motion vectors in one view that are the same as those motion vectors at a same position in a different view, the difference vector obtained from the different view may be re-used without any additional signaling of the motion vector. Similarly, spatially scalable codecs may also use an upsampled lower layer residual signal as a prediction of a residual signal of a high resolution layer, and then only encode difference between the upsampled lower layer residual signal and the high resolution layer residual signal in the higher resolution layer. In a further embodiment, this difference may also be shared between multiple views in order to reduce signaling required for some of the views.

Note that in both of the above embodiments, the motion vectors and residuals derived for a particular view that has not been previously encoded may be based on actual motion vectors and residuals of a previously coded view. Also, it should be noted that this particular view has not been previously encoded at a particular time instant t as well as time instants prior to time instant t. In such a case, the actual motion vectors and residuals may also be used only as predictors of corresponding parameters (motion vectors and residuals) of the particular view and a prediction error may be signaled for the new view. This method can allow the parameters to be signaled with increased coding efficiency for the particular view when compared to simply using the previous layer's information.

A combination of the previous layer's information as well as information from a different view of a current layer may also be used in order to further improve prediction accuracy for a particular view to be encoded. For example, a Lagrangian optimization technique may be used to perform a decision at a level of a block of pixels to determine coding mode for the block by considering cost, which is to be defined below. In this case, the coding mode may involve, for instance, a prediction mode that depends on the particular view from a previous layer, a prediction mode that depends on one or more views of the current layer, or a prediction mode that only depends on the particular view in the current layer. In the last case, the prediction mode may depend, for instance, on temporal prediction based on the particular view in a previously coded image from the current layer. Specifically, the prediction mode, in this case, generally includes motion vectors and/or residuals. Cost of choosing a particular prediction mode will depend on factors such as number of bits required to signal the mode, number of bits required to encode a motion vector and/or prediction residual, computational complexity of decoding, as well as power and memory requirements for decoding. Approximations of the signaling bits and prediction residual bits may also be performed in order to reduce computational complexity of the optimization.

The previously described embodiments can also be combined with the scheme illustrated in FIG. 8 in order to improve perceptual quality of displayed video. FIG. 8 illustrates a scheme in which views that are interpolated (862, 865) from low resolution versions (850, 852) and views that are encoded at high resolution (870, 872) are alternated in time such that a viewer will perceive each view (850, 852), V₀ (850) and V₁ (852) in FIG. 8, in both its low and high resolution forms. It should be noted that although FIG. 8 shows only two views for simplicity purposes, the scheme shown in FIG. 8 can be expanded to include many additional views. Such a scheme avoids causing one view to be of constantly lower quality than the other view or views, and thereby the scheme can potentially yield a better viewing experience.

In one embodiment of the multi-view case, different, possibly overlapping, segments of the video may contain different sets of views at high resolution. In another embodiment, a different configuration can be used in which some views are encoded at a low spatial resolution and high temporal resolution while other views are encoded at a high spatial resolution but low temporal resolution. Again, as in FIG. 8, the encoding of the views may be alternated in time, as well, to avoid causing one view to be of constantly lower spatial or temporal resolution.

Methods similar to that shown in FIG. 8 can be further enhanced by use of temporal information. For example, as shown in FIG. 8, decoded full resolution images of V₀ are available at time n−1 (870) and n+1 (872). In a more general case, additional full resolution images from other neighboring time slots may also be available. In addition to images encoded at full resolution, images from previous time slots that have already been upsampled to full resolution may also be available.

Therefore, a process that generates the upsampled image of V₀ at time n (862) may also use any of those previously decoded or upsampled images to derive an upsampled image at time n based on measurements similar to “closeness” measurements as previously presented. For example, one possibility is to average images derived from upsampling from a previous spatial resolution layer with images derived from temporal neighbors. In deriving the images from the temporal neighbors, known motion information may be used to temporally interpolate and construct a hypothetical image at time n. Motion compensated temporal filtering techniques may also be used to filter between the spatially upsampled image and its temporal neighbors.

It should be noted that each of the previously described embodiments may also be used as techniques to improve error resilience as well as transmission channel and network adaptability of a frame compatible scalable multi-view video delivery scheme. For example, the above methods can be combined with an additional enhancement layer or layers that provide high resolution information for all of the views. In that case, video packets containing these additional layers may be dropped adaptively depending on channel and network conditions and the embodiments described above may be used instead to obtain a graceful degradation of the quality of the multi-view sequence. This graceful degradation is in contrast to, for instance, a dropping of information from entire enhancement layers or even the base layer itself, which would yield noticeable degradation.

In another embodiment, unequal error protection may be provided such that some views are better protected from errors in the transmission channel than others. In that case, the enhancement layer packets of views that are less protected may be lost due to channel errors, and high resolution versions of the lost views may be generated using any of the above embodiments.

In another embodiment, additional metadata that describes relationships between views may be provided in a bitstream. It should be noted that the bitstream may be the same bitstream used to transfer base layer information and/or enhancement layer information or the bitstream may be a separate bitstream. Such metadata may, for instance, include a description of which views, or regions from each view, are more correlated; which transformations can be used to approximate one view, or region of one view from a region of another view; which characteristics are common between different views; and so forth. The characteristics may include statistics comparing the different views, such as mean and variance of luma and chroma components and histograms of luma and chroma components, as well as positions of particular elements between views.

In conclusion, this disclosure describes a set of schemes that can be used to provide frame compatible multiview video delivery within a scalable video coding framework. The schemes are aimed at reducing bit rate requirements for encoded video by exploiting two features intrinsic to multiview video. One feature is the inter-view masking effect that enables some views to be coded at lower resolution/quality with little perceptual degradation. The other feature is high correlation that can exist between different views that enables sharing of information between views.

The methods and systems described in the present disclosure may be implemented in hardware, software, firmware, or combination thereof. Features described as blocks, modules, or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

As described herein, an embodiment of the present invention may thus relate to one or more of the example embodiments that are enumerated in Table 1, below. Accordingly, the invention may be embodied in any of the forms described herein, including, but not limited to the following Enumerated Example Embodiments (EEEs) which described structure, features, and functionality of some portions of the present invention.

TABLE 1
ENUMERATED EXAMPLE EMBODIMENTS

EEE1. A frame compatible multiview video encoding system adapted to receive information
from a plurality of views, comprising:
a base layer comprising a base layer encoder, wherein the base layer encoder encodes
information from the plurality of views to obtain a first encoded frame compatible image; and
one or more enhancement layers, wherein each enhancement layer is associated with
the base layer and each enhancement layer comprises an enhancement layer encoder, wherein
at least one view and less than the entirety of views in the plurality of views is encoded by the
enhancement layer encoder to obtain a set of encoded images.
EEE2. A frame compatible multiview video encoding system adapted to receive information
from a plurality of views, comprising:
a base layer comprising a base layer encoder, wherein the base layer encoder encodes
information from the plurality of views to obtain a first encoded frame compatible image; and
one or more enhancement layers, wherein:
each enhancement layer is associated with the base layer,
each enhancement layer comprises an enhancement layer encoder,
the entirety of views in the plurality of views is encoded by at least one of the
enhancement layer encoders,
at least one view and less than the entirety of views in the plurality of views is
encoded by each remaining enhancement layer encoder,
the enhancement layer encoders generate a set of encoded images.
EEE3. The encoding system of Enumerated Example Embodiment 1 or 2, wherein
interpolation is performed on one or more of the views in the first encoded frame compatible
image by a filter selected from the group consisting of 1D FIR, 2D FIR, bilinear, bicubic,
edge adaptive, bilateral, edgelet-based, and bandlet-based filters.
EEE4. The encoding system of Enumerated Example Embodiment 1, further comprising a
filter generating unit for generating filter modes, wherein:
the filter generating unit comprises one input from each of the at least one and less
than the entirety of views in the plurality of views,
the filter modes are used to perform interpolation of views in the first encoded frame
compatible image, and
the filter modes are adapted to be signaled to a decoding system.
EEE5. The encoding system of Enumerated Example Embodiment 4, wherein the filter
generating unit generates a filter selected from the group consisting of 1D FIR, 2D FIR,
bilinear, bicubic, edge adaptive, bilateral, edgelet-based, and bandlet-based filters.
EEE6. The encoding system of Enumerated Example Embodiment 4 or 5, wherein the filter
modes are determined based on a full set or subset of views in the first encoded frame
compatible image and a full set or subset of views in at least one image in the set of encoded
images.
EEE7. The encoding system of Enumerated Example Embodiment 6, wherein the filter
modes are determined based on the full set or subset of the views in the at least one image in
the set of encoded images and corresponding view or views from the first encoded frame
compatible image.
EEE8. The encoding system of Enumerated Example Embodiment 7, wherein the filter
modes are determined based on a difference between at least one view from the at least one
image in the set of encoded images and corresponding view or views obtained from the first
encoded frame compatible image.
EEE9. The encoding system of Enumerated Example Embodiment 8, wherein the difference
is a minimized difference selected from the group consisting of a minimum mean squared
error, sum of absolute differences, sum of transformed absolute differences, and sum of
absolute weighted transformed absolute differences.
EEE10. The encoding system of Enumerated Example Embodiment 8, wherein the difference
is based on distortion measures comprising at least one of structural similarity (SSIM),
weighted PSNR, and VDP.
EEE11. The encoding system of Enumerated Example Embodiment 8, wherein the difference
is based on image characteristics comprising at least one of similarity of edges and texture,
similarity of first and second order moments, and similarity of frequency characteristics
between the at least one image in the set of encoded images and corresponding view or views
from the first encoded frame compatible image.
EEE12. The encoding system of any one of Enumerated Example Embodiments 4-11,
wherein the filter modes are derived for different spatial and/or temporal regions of the first
encoded frame compatible image and the at least one image in the set of encoded images, and
wherein one set of filter parameters is derived for each spatial and/or temporal region.
EEE13. The encoding system of Enumerated Example Embodiment 12, wherein filter modes
derived for a particular region are adapted for use in interpolating co-located regions in the
full set or subset of views in the first encoded frame compatible image.
EEE14. The encoding system of Enumerated Example Embodiment 12, wherein disparity
estimation is performed between views in the full set or subset of views in the first encoded
frame compatible image, and wherein filter modes applied to a particular region are the filter
modes derived from another region of highest spatial correlation to the particular region.
EEE15. The encoding system of Enumerated Example Embodiment 12, wherein filter modes
derived for a particular position are adapted for use in interpolating co-located positions in
the full set or subset of views in the first encoded frame compatible image.
EEE16. The encoding system of Enumerated Example Embodiment 12, wherein disparity
estimation is performed between views in the full set or subset of views in the first encoded
frame compatible image, and wherein filter modes applied to a particular position are the
filter modes derived from another position of highest spatial correlation to the particular
position.
EEE17. The encoding system of any one of Enumerated Example Embodiments 4-16,
wherein the filter modes are filter parameters or filter indices, and wherein the filter indices
provide information on type of filter to use for decoding the first encoded frame compatible
image and the set of encoded images (330) at the decoding system.
EEE18. The encoding system of Enumerated Example Embodiment 1 or 2, further
comprising one or more inter-layer predictors between a first layer and an alternative layer,
wherein:
the first layer is any one of the base layer or the one or more enhancement layers and
the alternative layer is any layer that is not the first layer,
each of the one or more inter-layer predictors corresponds to a view in the plurality of
views,
each of the one or more inter-layer predictors receives an input from a full set or
subset of the plurality of views or receives an input from another inter-layer predictor,
each of the one or more inter-layer predictors generates inter-layer prediction
information corresponding to a view in the plurality of views, and
the inter-layer prediction information corresponding to a particular view is adapted for
generating an interpolated version of the particular view.
EEE19. The encoding system of Enumerated Example Embodiment 18, wherein the inter-
layer prediction information is based on a motion vector from a lower layer encoder and a
motion vector for a co-located region in a higher layer encoder.
EEE20. The encoding system of Enumerated Example Embodiment 19, wherein the motion
vector for the co-located region of the higher layer encoder is a prediction based on the
motion vector from the lower layer encoder.
EEE21. The encoding system of Enumerated Example Embodiment 18, wherein the inter-
layer prediction information comprises an upsampled lower layer residual signal from a lower
layer encoder, and wherein a higher layer residual signal is a prediction based on the
upsampled lower layer residual signal.
EEE22. The encoding system of Enumerated Example Embodiment 21, wherein the inter-
layer prediction information comprises a difference between the upsampled lower layer
residual signal and the high layer residual signal.
EEE23. The encoding system of Enumerated Example Embodiment 18, wherein the inter-
layer prediction information of a particular view is a prediction error based on motion vectors
and/or residual signals of a previously coded view.
EEE24. The encoding system of any one of Enumerated Example Embodiments 18-23,
wherein the inter-layer prediction information for the particular view is based on inter-layer
prediction information from one or more alternative views.
EEE25. The encoding system of any one of Enumerated Example Embodiments 18-24,
wherein the inter-layer prediction information is based on at least one of the particular view
in a previous layer, one or more views in a current layer, and the particular view in the
current layer.
EEE26. The encoding system of Enumerated Example Embodiment 25, wherein a plurality of
prediction modes are generated from the inter-layer prediction information, and a particular
prediction mode from the plurality of prediction modes is chosen based on at least one of
number of bits needed to signal the particular prediction mode, number of bits needed to
signal the inter-layer prediction information, computational complexity at a decoding step,
power requirements at the decoding step, and memory requirements at the decoding step.
EEE27. The encoding system of Enumerated Example Embodiment 26, wherein the
prediction mode is obtained using a Lagrangian optimization technique.
EEE28. The encoding system of any one of Enumerated Example Embodiments 18-27,
wherein the inter-layer prediction information is adapted for signaling to a decoding system.
EEE29. The encoding system of any one of Enumerated Example Embodiments 1-28,
wherein:
a particular view is encoded at a low spatial resolution and a high temporal resolution
at a first set of time instants, and
the particular view is encoded at a high spatial resolution and a low temporal
resolution at a second set of time instants.
EEE30. The encoding system of any one of Enumerated Example Embodiments 1-29, further
comprising at least one additional enhancement layer, wherein a full set of the views in the
plurality of views are encoded by an additional enhancement layer encoder.
EEE31. The encoding system of any one of Enumerated Example Embodiments 1-30, further
comprising metadata, wherein the metadata provides information relating one view, or region
within the view, with each view in a full set or subset of the plurality of views, or regions
within each view in the full set or subset of the plurality of views.
EEE32. The encoding system of Enumerated Example Embodiment 31, wherein the metadata
provides information comprising at least one of correlation information, transformation
information to generate one view from another view, and image characteristics.
EEE33. The encoding system of Enumerated Example Embodiment 32, wherein the image
characteristics are at least one of:
mean of luma and/or chroma components,
variance of the luma and/or chroma components, and
positions of particular elements in each of the views.
EEE34. A multiview video decoding system adapted to receive information from a plurality
of views, comprising:
a base layer comprising a base layer decoder adapted to receive the information from
the plurality of views and adapted to decode the information from the plurality of views to
obtain a first decoded frame compatible image;
one or more enhancement layers, wherein each enhancement layer is associated with
the base layer and each enhancement layer comprises an enhancement layer decoder, wherein
the one or more enhancement layers are adapted to receive information from at least one and
less than the entirety of views in the plurality of views and adapted to decode the information
from the at least one and less than the entirety of views in the plurality of views to obtain a
set of decoded images; and
an upsampling module comprising an input from the base layer decoder and one input
from each enhancement layer decoder, wherein the upsampling module performs
interpolation on a full set or subset of views in the plurality of views.
EEE35. A multiview video decoding system adapted to receive information from a plurality
of views, comprising:
a base layer comprising a base layer decoder adapted to receive the information from
the plurality of views and adapted to decode the information from the plurality of views to
obtain a first decoded frame compatible image; and
one or more enhancement layers, wherein:
each enhancement layer is associated with the base layer,
each enhancement layer comprises an enhancement layer decoder,
at least one of the enhancement layer decoders is adapted to receive and
decode the entirety of views in the plurality of views,
each remaining enhancement layer decoder is adapted to receive and decode at
least one and less than the entirety of views in the plurality of views, and
the enhancement layer decoders generate a set of decoded images.
EEE36. The decoding system of Enumerated Example Embodiment 34, wherein:
the upsampling module performs interpolation using a filter, and
filter modes of the filter are determined based on a full set or subset of views in the
first decoded frame compatible image and a full set or subset of views in at least one image in
the set of decoded images.
EEE37. The decoding system of Enumerated Example Embodiment 34 or 36, wherein the
upsampling module performs interpolation on one or more views in the first decoded frame
compatible image using a filter selected from the group consisting of 1D FIR, 2D FIR,
bilinear, bicubic, edge adaptive, bilateral, edgelet-based, and bandlet-based filters.
EEE38. The decoding system of Enumerated Example Embodiment 36, wherein the filter
modes are determined based on the full set or subset of views in the at least one image in the
set of decoded images and corresponding view or views from the first decoded frame
compatible image.
EEE39. The decoding system of Enumerated Example Embodiment 38, wherein the filter
modes are determined based on a difference between at least one view from the full set or
subset of the at least one image in the set of decoded images and corresponding view or
views obtained from the first decoded frame compatible image.
EEE40. The decoding system of Enumerated Example Embodiment 39, wherein the
difference is a minimized difference selected from the group consisting of a minimum mean
squared error, sum of absolute differences, sum of transformed absolute differences, and sum
of absolute weighted transformed absolute differences.
EEE41. The decoding system of Enumerated Example Embodiment 39, wherein the
difference is based on distortion measures comprising at least one of structural similarity
(SSIM), weighted PSNR, and VDP.
EEE42. The decoding system of Enumerated Example Embodiment 39, wherein the
difference is based on image characteristics comprising at least one of similarity of edges and
texture, similarity of first and second order moments, and similarity of frequency
characteristics between the at least one image in the set of decoded images and corresponding
view or views from the first decoded frame compatible image.
EEE43. The decoding system of any one of Enumerated Example Embodiments 34 and 36-42,
wherein:
the upsampling module generates interpolated samples for the full set or subset of
views in the first decoded frame compatible image,
decoded samples from the at least one image in the set of decoded images for
corresponding views are combined with the interpolated samples to obtain a combined view,
and
the combined view is a weighted combination of the full set or subset of views.
EEE44. The decoding system of Enumerated Example Embodiment 43, wherein disparity
estimation is performed between views in the full set or subset of views in the first decoded
frame compatible image.
EEE45. The decoding system of any one of Enumerated Example Embodiments 36-42,
wherein the filter modes are derived for different spatial and/or temporal regions of the first
decoded frame compatible image and the at least one image in the set of decoded images, and
wherein one set of filter modes is derived for each spatial and/or temporal region.
EEE46. The decoding system of Enumerated Example Embodiment 45, wherein filter modes
derived for a particular region are used to interpolate co-located regions in the full set or
subset of views in the first decoded frame compatible image.
EEE47. The decoding system of Enumerated Example Embodiment 46, wherein disparity
estimation is performed between views in the full set or subset of views in the first decoded
frame compatible image, and wherein filter modes applied to a particular region are the filter
modes derived from another region of highest spatial correlation to the particular region.
EEE48. The decoding system of Enumerated Example Embodiment 45, wherein filter modes
derived for a particular position are adapted for use in interpolating co-located positions in
the full set or subset of views in the first decoded frame compatible image.
EEE49. The decoding system of Enumerated Example Embodiment 45, wherein disparity
estimation is performed between views in the full set or subset of views in the first decoded
frame compatible image, and wherein filter modes applied to a particular position are the
filter modes derived from another position of highest spatial correlation to the particular
position.
EEE50. The decoding system of Enumerated Example Embodiment 34, wherein the
upsampling module receives the filter modes from an encoding system.
EEE51. The decoding system of any one of Enumerated Example Embodiments 34-50,
wherein:
a particular view is encoded by at least one encoder and decoded by corresponding
decoders in a first set of time instants, and
the particular view is upsampled in a second set of time instants.
EEE52. The decoding system of Enumerated Example Embodiment 51, wherein upsampling
of the particular view in the second set of time instants is based on previously decoded
images or previously upsampled images.
EEE53. The decoding system of Enumerated Example Embodiment 52, wherein the
upsampling of the particular view in the second set of time instants is based on an average of
the previously decoded images or the previously upsampled images.
EEE54. The decoding system of any one of Enumerated Example Embodiments 34-50,
wherein:
a particular view is encoded at a low spatial resolution and a high temporal resolution
at a first set of time instants, and
the particular view is encoded at a high spatial resolution and a low temporal
resolution at a second set of time instants.
EEE55. The decoding system of any one of Enumerated Example Embodiments 34-54,
wherein the decoding system is adapted to receive metadata providing information relating
one view, or region within the view, with each view in a full set or subset of the plurality of
views, or regions within each view in the full set or subset of the plurality of views.
EEE56. The decoding system of Enumerated Example Embodiment 55, wherein the metadata
provides information comprising at least one of correlation information, transformation
information to generate one view from another view, and image characteristics.
EEE57. The decoding system of Enumerated Example Embodiment 56, wherein the image
characteristics are at least one of:
mean of luma and/or chroma components,
variance of the luma and/or chroma components, and
positions of particular elements in each of the views.
EEE58. The decoding system of any one of Enumerated Example Embodiments 51-53,
wherein the at least one encoder is the encoding system of any one of Enumerated Example
Embodiments 1-33.
EEE59. A method for deriving interpolation filters, the interpolation adapted for use in a
multiview video coding system, the multiview video coding system comprising a base layer
and one or more enhancement layers, the method comprising:
a) providing a first coded image based on a plurality of views;
b) providing at least one coded image based on at least one and less than the entirety
of views in the plurality of views; and
c) generating filter modes for the interpolation filters based on views in the first
coded image and the at least one coded image.
EEE60. The method of Enumerated Example Embodiment 59, wherein the first coded image
comprises low resolution versions of each view in the plurality of views and the at least one
coded image comprises high resolution versions of the subset of views in the plurality of
views.
EEE61. The method of Enumerated Example Embodiment 59 or 60, wherein the filter modes
are generated based on at least one view in the at least one coded image and corresponding
view or views from the first coded image.
EEE62. The method of any one of Enumerated Example Embodiments 59-61, wherein the
filter modes are generated based on a difference between at least one view in the at least one
coded image and corresponding view or views from the first coded image.
EEE63. The method of Enumerated Example Embodiment 62, wherein the difference is a
minimized difference selected from the group consisting of a minimum mean squared error,
sum of absolute differences, sum of transformed absolute differences, and sum of absolute
weighted transformed absolute differences.
EEE64. The method of Enumerated Example Embodiment 62, wherein the difference is
based on distortion measures comprising at least one of structural similarity (SSIM),
weighted PSNR, and VDP.
EEE65. The method of Enumerated Example Embodiment 62, wherein the difference is
based on image characteristics comprising at least one of similarity of edges and texture,
similarity of first and second order moments, and similarity of frequency characteristics
between the at least one coded image and corresponding view or views from the first coded
image.
EEE66. The method of any one of Enumerated Example Embodiments 59-65, wherein the
filter modes are generated for different spatial and/or temporal regions of the first coded
image and the at least one coded image, and wherein one set of filter modes are derived for
each spatial and/or temporal region.
EEE67. The method of any one of Enumerated Example Embodiments 59-66, wherein the
filter modes are filter parameters or filter indices, wherein the filter indices are adapted to
provide information on type of filter to use in a decoding system.
EEE68. A method for performing interpolation on a full set or subset of views in a first coded
image based on at least one coded image, the first coded image comprising information from
a plurality of views, and the at least one coded image comprising information from a subset
of the plurality of views, the method comprising:
a) deriving interpolation filters according to the method of any one of Enumerated
Example Embodiments 59-67; and
b) filtering the first coded image using the interpolation filters obtained from the step
of deriving.
EEE69. A method for performing interpolation on a full set or subset of views in a first coded
image based on at least one coded image, the first coded image comprising information from
a plurality of views, and the at least one coded image comprising information from a subset
of the plurality of views, the method comprising:
a) deriving interpolation filters based on filter modes received from an encoder; and
b) filtering the first coded image using the interpolation filters obtained from the step
of deriving,
wherein the filter modes are filter parameters or filter indices, and wherein the filter
indices are adapted to provide information on type of filter to use for decoding the first coded
image and the at least one coded image.
EEE70. The method of Enumerated Example Embodiment 69, wherein the encoder is the
encoding system of any one of Enumerated Example Embodiments 1-33.
EEE71. The method of any one of Enumerated Example Embodiments 68-70, wherein the
interpolation filters derived for a particular region are used in interpolating co-located regions
in a full set or subset of views in the first coded image.
EEE72. A method for decoding a particular view of a coded image, the coded image adapted
for use in a multiview video coding system, the method comprising:
deriving an interpolation filter for the particular view according to the method of any
one of Enumerated Example Embodiments 59-67;
decoding the particular view from the coded image in a first set of time instants,
wherein in the first set of time instants the particular view is encoded in high resolution; and
upsampling the first coded image using the interpolation filters obtained from the step
of deriving in a second set of time instants, wherein in the second set of time instants the
particular view is encoded in low resolution.
EEE73. The method of Enumerated Example Embodiment 72, wherein the upsampling of the
particular view in the second set of time instants is based on previously decoded images or
previously upsampled images.
EEE74. The method of Enumerated Example Embodiment 73, wherein the upsampling of the
particular view in the second set of time instants is based on an average of the previously
decoded images or the previously upsampled images.
EEE75. A method for encoding an image, the coded image adapted for use in a multiview
video coding system, the method comprising:
encoding a particular view at a low spatial resolution and a high temporal resolution
in a first set of time instants; and
encoding the particular view at a high spatial resolution and a low temporal resolution
in a second set of time instants.
EEE76. A method for encoding an image, the coded image adapted for use in a multiview
video coding system, the method comprising:
encoding a particular view at a high resolution in a first set of times instants; and
encoding the particular view at a low resolution in a second set of time instants.
EEE77. A decoding system for decoding a video signal according to the method recited in
one or more of Enumerated Example Embodiments 72-74.
EEE78. An encoding system for encoding a video signal according to the method recited in
one or more of Enumerated Example Embodiments 75-76.
EEE79. A computer-readable medium containing a set of instructions that causes a computer
to perform the method recited in one or more of Enumerated Example Embodiments 59-76.
EEE80. A codec system comprising the encoding system of any one of Enumerated Example
Embodiments 1-33 and the decoding system of any one of Enumerated Example
Embodiments 34-58.

Furthermore, all patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiments of the scalable frame compatible multiview encoding and decoding systems and methods of the disclosure, and are not intended to limit the scope of what the inventors regard as their disclosure. Modifications of the above-described modes for carrying out the disclosure may be used by persons of skill in the video art, and are intended to be within the scope of the following Claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended Claims, the singular forms “a”, “an”, and “the” include plural referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following Claims.

### LIST OF REFERENCES

[1] Advanced video coding for generic audiovisual services, http://www.itu.int/rec/T-REC-H.264/e, March 2010.
[2] H. Schwarz, D. Marpe, and T. Wiegand, “Overview of the Scalable Video Coding Extension of the H.264/AVC Standard,” IEEE Transactions on Circuits and Systems for Video Technology, Vol. 17, No. 9, pp. 1103-1120, 2007.
[3] L. B. Stelmach, W. J. Tam, D. Meegan, and A. Vincent, “Stereo image quality: Effects of mixed spatio-temporal resolution,” IEEE Transactions on Circuits and Systems for Video Technology, Vol. 10, pp. 188-193, 2000.

1-21. (canceled)

22. A frame compatible multiview video encoding system adapted to receive information from a plurality of views, comprising:
a base layer comprising a base layer encoder, wherein the base layer encoder encodes information from the plurality of views to obtain a first encoded frame compatible image, the first encoded frame compatible image thus comprising a plurality of base layer encoded views;
one or more enhancement layers, wherein each enhancement layer is associated with the base layer and each enhancement layer comprises an enhancement layer encoder, wherein at least one view and less than the entirety of views in the plurality of views is encoded by the enhancement layer encoder to obtain a set of encoded view images, each encoded view image being associated with a view among the at least one view and less than the entirety of views; and
a filter generating unit for generating filter modes, wherein:
the filter modes are used to perform interpolation of views in the first encoded frame compatible image and are adapted to be signaled to a decoding system,
at least one filter mode is generated based on at least a base layer encoded view among the plurality of base layer encoded views and a corresponding encoded view image among the set of encoded view images, and
the at one filter mode is used to perform interpolation of one or more views in the plurality of views.

23. A frame compatible multiview video encoding system adapted to receive information from a plurality of views, comprising:
a base layer comprising a base layer encoder, wherein the base layer encoder encodes information from the plurality of views to obtain a first encoded frame compatible image, the first encoded frame compatible image thus comprising a plurality of base layer encoded views;
one or more enhancement layers, wherein:
each enhancement layer is associated with the base layer,
each enhancement layer comprises an enhancement layer encoder,
the entirety of views in the plurality of views is encoded by at least one of the enhancement layer encoders,
at least one view and less than the entirety of views in the plurality of views is encoded by each remaining enhancement layer encoder, and
the enhancement layer encoders generate a set of encoded view images; and
a filter generating unit for generating filter modes, wherein:
the filter modes are used to perform interpolation of views in the first encoded frame compatible image and are adapted to be signaled to a decoding system,
at least one filter mode is generated based on at least a base layer encoded view among the plurality of base layer encoded views and a corresponding encoded view image among the set of encoded view images, and
the at one filter mode is used to perform interpolation of one or more views in the plurality of view.

24. The encoding system as recited in claim 22, wherein interpolation is performed on one or more of the views in the first encoded frame compatible image by a filter selected from the group consisting of 1D FIR, 2D FIR, bilinear, bicubic, edge adaptive, bilateral, edgelet-based, and bandlet-based filters.

25. The encoding system as recited in claim 22, wherein the filter generating unit comprises one input from each of the at least one and less than the entirety of views in the plurality of views.

26. The encoding system as recited in claim 25, wherein the filter generating unit generates a filter selected from the group consisting of 1D FIR, 2D FIR, bilinear, bicubic, edge adaptive, bilateral, edgelet-based, and bandlet-based filters.

27. The encoding system as recited in claim 25, wherein the filter modes are determined based on a full set or subset of views in the first encoded frame compatible image and a full set or subset of views in at least one image in the set of encoded images.

28. The encoding system as recited in claim 27, wherein the filter modes are determined based on the full set or subset of the views in the at least one image in the set of encoded images and corresponding view or views from the first encoded frame compatible image.

29. The encoding system as recited in claim 28, wherein the filter modes are determined based on a difference between at least one view from the at least one image in the set of encoded images and corresponding view or views obtained from the first encoded frame compatible image.

30. The encoding system as recited in claim 29, wherein the difference is a minimized difference selected from the group consisting of a minimum mean squared error, sum of absolute differences, sum of transformed absolute differences, and sum of absolute weighted transformed absolute differences.

31. The encoding system as recited in claim 29, wherein the difference is based on distortion measures comprising at least one of structural similarity (SSIM), weighted PSNR, and VDP.

32. The encoding system as recited in claim 29, wherein the difference is based on image characteristics comprising at least one of similarity of edges and texture, similarity of first and second order moments, and similarity of frequency characteristics between the at least one image in the set of encoded images and corresponding view or views from the first encoded frame compatible image.

33. The encoding system as recited in claim 25, wherein the filter modes are derived for different spatial and/or temporal regions of the first encoded frame compatible image and the at least one image in the set of encoded images, and wherein one set of filter parameters is derived for each spatial and/or temporal region.

34. A method for deriving interpolation filters in a multiview video coding system, the multiview video coding system comprising a base layer and one or more enhancement layers, the method comprising:
a) providing a first coded image by coding information at the base layer from a plurality of views, the first coded image thus comprising a plurality of base layer coded views;
b) providing a set of coded view images by coding information at the one or more enhancement layers from at least one view and less than the entirety of views in the plurality of views; and
c) deriving interpolation filters, wherein each interpolation filter is configured to be derived by generating a filter mode based on at least a base layer coded view among the plurality of base layer coded views and a corresponding coded view image among the set of coded view images.

35. The method as recited in claim 34, wherein:
the interpolation filters are derived at an encoder and adapted to be signaled to a decoder,
the filter modes are filter parameters or filter indices, and
the filter indices are adapted to provide information on type of filter to use for decoding the first coded image and the set of coded view images.

36. The method as recited in claim 35, wherein the encoder is the encoding system of claim 22.

37. The method as recited in claim 34, wherein the interpolation filters derived for a particular region are used in interpolating co-located regions in a full set or subset of views in the first coded image.

38. A method for decoding a particular view of a coded image, the coded image adapted for use in a multiview video coding system, the method comprising:
deriving an interpolation filter for the particular view according to the method as recited in claim 34;
decoding the particular view from the coded image in a first set of time instants, wherein in the first set of time instants the particular view is encoded in high resolution; and
upsampling the first coded image using the interpolation filters obtained from the step of deriving in a second set of time instants, wherein in the second set of time instants the particular view is encoded in low resolution.

39. A decoding system for performing a method as recited in claim 34.

40. A decoding system for decoding a video signal encoded with an encoding system as recited in claim 22.

41. A computer-readable storage medium containing a set of instructions that causes a computer to perform one or more of:
a method as recited in claim 34;
program, configure or control an encoding system as recited in claim 22; or
program, configure or control a decoding system as recited in claim 39.

42. A codec system, comprising:
an encoding system as recited in claim 22; and
a decoding system as recited in claim 39.

43. The encoding system as recited in claim 22, wherein the first encoded frame compatible image comprises lower resolution versions of each view among the plurality of views and the set of encoded view images comprise higher resolution versions of views in the at least one view and less than the entirety of views.

44. The encoding system as recited in claim 22, wherein the at least one filter mode is used to perform interpolation of one or more views not among the at least one view and less than the entirety of views associated with the set of encoded view images.
